(19) United States
(12) Patent Application Publication
(10) Pub. No.: US 2017/0102699 A1
(43) Pub. Date: Apr. 13, 2017

(54) DRONE CONTROL THROUGH IMAGERY

(71) Applicant: Intel Corporation, Santa Clara, CA (US)

(72) Inventor: Glen J. Anderson, Beaverton, OR (US)

(21) Appl. No.: 14/579,253

(22) Filed: Dec. 22, 2014

(51) Int. Cl. G05D 1/00; G06K 9/00; B64C 39/02

(52) U.S. Cl. CPC G05D 1/0038; G05D 1/0016; B64C 39/024; G06K 9/0063; B64C 2201/146; G06F 3/04842

(57) ABSTRACT

A system may include a communication subsystem to receive image data from a drone; an object detection and recognition module to generate a model representation of the image data, the model representation identifying at least one actionable object in the image data; a display device to present the image data; and a control module to: detect a control input associated with an object of the at least one actionable object; and transmit a control instruction to the drone based on the control input.

### TECHNICAL FIELD

Embodiments described herein generally relate to robotic control, including but not by way of limitation to drone control through imagery.

### BACKGROUND

Drones, such as unmanned aerial vehicles (UAVs), may be controlled via a variety of modes such as autonomously, semi-autonomously, or manually. For example, an autonomous UAV may be programmed with a path using waypoints (e.g., latitude, longitude, elevation) that the UAV follows and the returns back to its origination point. A semi-autonomous UAV may be programmed to navigate to a specific spot and then wait for further instructions. Manual control may include a user using a remote control. In any of the use cases the drone may have onboard sensors to help it from crashing. For example, the drone may have proximity sensors to prevent the drone from hitting a building—regardless of the control mode.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating components of a drone and a remote control, according various examples;

FIG. 2 is a flow chart illustrating a method to control a drone, according to various examples;

FIG. 3 illustrates a user interface for controlling a drone, according to various examples;

FIG. 4 illustrates a hover command on a user interface for controlling a drone, according to various examples;

FIG. 5 illustrates a focus command on a user interface for controlling a drone, according to various examples;

FIGS. 6A and 6B illustrate a navigation command on a user interface for controlling a drone, according to various examples;

FIG. 7 illustrates a removal command on a user interface of a remote control, according to various examples;

FIG. 8 is a flow chart illustrating a method to control a drone, according to various examples; and

FIG. 9 is a block diagram of machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

In various examples, user interfaces (UI) for control of semi-autonomous vehicles (e.g., land-based vehicle, unmanned aerial vehicles (UAVs), maritime vehicles, robots, etc.) may display a variety of information. For example, a UI may display a map of an area and allow a user to select waypoints that the semi-autonomous vehicle may follow. Additionally, a UI may include image data transmitted from the semi-autonomous vehicle.

In various examples described herein, a semi-autonomous vehicle may capture images during operation. These images may be transmitted back to a remote control that, at least partially, operates semi-autonomous vehicle. The image data may be analyzed to determine objects in view of the semi-autonomous vehicle that may be acted upon by a user—thereby creating a model representation of the image data. An operator of the semi-autonomous vehicle may then interact with the objects in the analyzed image data to give additional commands to the semi-autonomous vehicle.

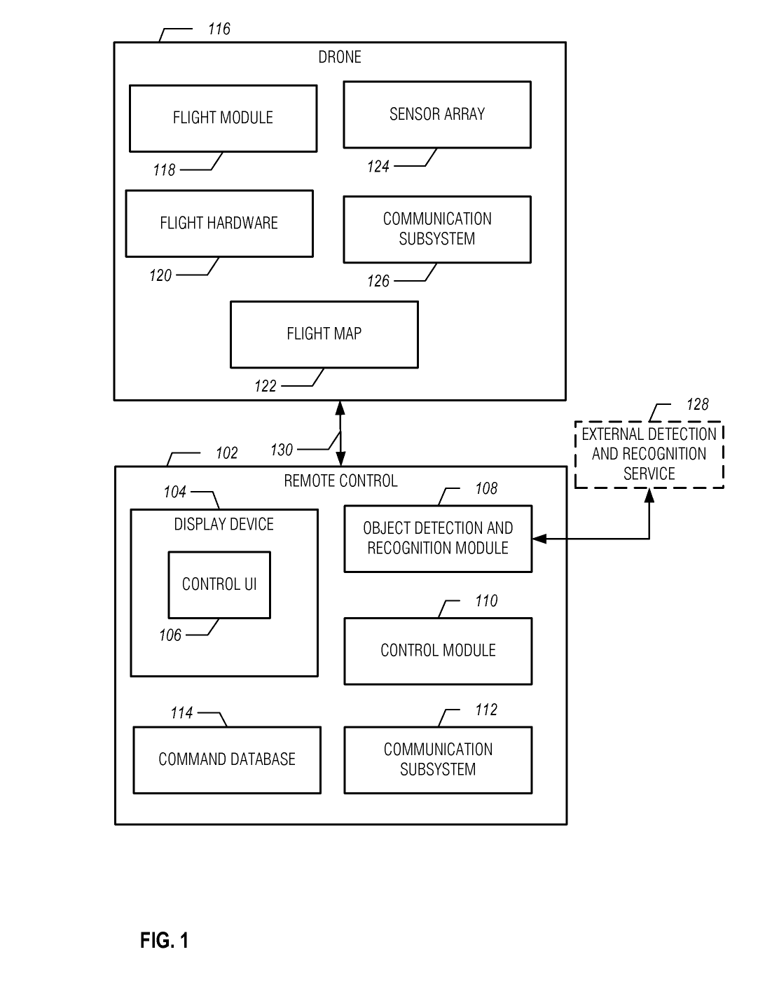

FIG. 1 is a block diagram illustrating components of a drone 116 and a remote control 102, according various examples. In various examples, the drone 116 includes a flight module 118, flight hardware 120, a flight map 122, a sensor array 124, and a communication subsystem 126. In various examples, the remote control 102 includes a display device 104, a control user interface 106, an object and recognition module 108, a control module 110, a communication subsystem 112, and a command database 114. Also illustrated are an external detection and recognition service 128 and a network connection 130 between the drone 116 and the remote control 102.

In an example, an drone 116 may be, but is not limited to drones such as unmanned aerial vehicles, unmanned ground vehicles cars, and unmanned marine vehicles. For discussion purposes, the drone 116 discussed herein is an unmanned aerial vehicle. The drone 116 may operate semi-autonomously based on commands received from the remote control 102. For example, when the drone 116 receives a navigation command that includes a destination—such as GPS coordinates and desired altitude—the drone 116 may move to the destination without further user input.

In various examples, the flight hardware 120 includes the components of the drone 116 that propel or otherwise move the drone 116. For example, for a quadroter UAV, the flight hardware 120 may include four propellers. The flight hardware 120 may differ depending on the type of drone 116. The flight hardware 120 may also include a GPS receiver.

The flight hardware 120 may also include at least one processing unit (e.g., a central processing unit, a graphical processor, an application-specific integrated circuit) that includes one or more cores. The at least one processing unit may execute software stored on the drone 116 to perform the functions described herein of the drone 116

In various examples, the flight map 122 includes data representing a geographic area including roads and their associated GPS coordinates. The flight map 122 includes altitude data of the geographic area. The data may also location data on man-made objects such as bridges, cell towers, etc. Furthermore, the flight map 122 may include a database of point-of-interest (POI) locations including, but not limited to restaurants, businesses, gas stations, stadiums, golf courses, etc.

In various examples, the sensor array 124 includes one or more sensors of the drone 116. Data captured by the sensor array 124 may be used internally by the drone 116 during navigation and/or externally by operators of the drone 116. Sensors may include, but are not limited to, temperature sensors, pressure sensors, electro-optical sensors, infrared sensors, depth cameras, camera arrays, microphone arrays, gyroscopes, accelerometers, proximity sensors, microphones, and magnetometers.

In various examples, autonomous movement of the drone 116 is accomplished using flight module 118 and one or more of the sensor array 124, the flight hardware 120, and the flight map 122. In an example, the flight module 118 includes collision detection logic. To this end, readings from a proximity sensor in the sensor array 124 may be used to determining how close the drone 116 is to an object. In an example, data stored in the flight map 122 is used to avoid objects. For example, the drone 116 may navigate around locations of known tall structures (e.g., cell towers, buildings) or fly to a sufficient height before proceeding to a location of such a structure.

The flight module 118 may also utilize image data taken using an electro-optical or infrared sensor to avoid collisions with objects. For example, the flight module 118 may analyze image data using pattern matching algorithms to classify an object in the path of the drone 116 before determining to move towards the object.

In various examples, the communication subsystem 126 includes one or more receivers, transmitters, or transceivers to communicate with the remote control 102 over one or more networks—the communications subsystem 112 may operate in a similar, but reverse fashion. In an example, a control instruction is received by the communication subsystem 126 over the network connection. The control instruction may indicate what the next course of action is for the drone 116. For example, the control instruction may be a navigation instruction, an object manipulation instruction, or an image instruction as described further herein. The communication subsystem 126 may relay the control instruction to the flight module 118 at which point the flight module 118 implements the instruction.

A network may include local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. The network 130 may include a single local area network (LAN) or wide-area network (WAN), or combinations of LAN's or WAN's, such as the Internet.

In various examples, the remote control 102 is a standalone device or part of an existing device. For example, the remote control 102 may be a smart phone executing a remote control application. In an example, the remote control 102 may be a web-based application. In an example, the remote control 102 is a tablet computer.

In various examples, the display device 104 is a display on the remote control 102 that presents the control user interface 106. The control user interface 106 may include image data received from the drone 116 via the network connection 130. Image data may include images files (e.g., JPEG, TIFF, PNG, BMP, etc.) or video files (H.264, H.265, VP8, AVC, etc.) of captured by electro-optical or infrared sensors on the drone 116.

In various examples, the object detection and recognition module 108 analyzes the image data received by the network connection 130 to determine one or more actionable objects. In an example, an actionable object is an object present in the image data that a user can select in the control user interface 106 and issue a command on. For example, the object detection and recognition module 108 may determine a bridge is present in the image data, a user may select the bridge on the control user interface 106, and the user may issue a control instruction to have the drone 116 move closer to the bridge.

In various examples, the object detection and recognition module 108 sends all or a portion of the image data to an external service for object recognition—such as external detection and recognition service 128. The external detection and recognition service 128 may be called by the remote control 102 over a network 130. For example, the object detection and recognition module 108 may send only the portion of the image within a predefined area around the user's point of touch on a touch screen as it correlates to the image that the user is acting upon.

In response to the call, the external detection and recognition service 128 may return data that identifies actionable objects in the image data. The return data may indicate the locations (e.g., pixel locations) that delineate the actionable object and a classification for the object (e.g., road, bridge, power line). To classify objects in the image data, the external detection and recognition service 128 may utilize pattern matching and object tracking algorithms to match the objects in the image data to previously classified objects. In an example, the remote control 102 performs the object detection and classification.

In various examples, the object detection and recognition module 108 or external detection and recognition service 128 may not recognize the identity of an object but direct the drone's flight by matching the area of the image touched by the user to current imagery being recorded by the drone's camera. When an area of the recorded image matches the touch area of the image, the drone may move closer to that area.

In various examples, the control module 110 responds to user input on the control user interface 106. User input may include touch input on the display device 104, voice input, hand gestures above the remote control 102, or physical movement of the remote control 102. Detection of the input may be accomplished using one or more sensors of the remote control 102 (not illustrated) such as accelerometers, microphones, gyroscopes, or cameras.

In various examples, the user input is a command to control the drone 116. In an example, the command includes a selection of an actionable object in the image data. For example, the user input may be a touch gesture that circles an actionable object present on the control user interface 106. In various examples, the command database 114 (e.g., flat file databases, relational databases, non-relational databases, or combinations thereof) stores data mapping user input commands with control instructions for the drone 116. For example, a circle input may map to a navigation instruction that tells the drone 116 to navigate to the actionable object. In an example, the command database 114 includes multiple control instructions for the same type of input based on drone type. Accordingly, control module 110 may query the command database 114 with both the type of input and the type of drone.

Accordingly, in an example, when user input is detected, the control module 110 may query the command database 114 and retrieve a control instruction for the drone 116. The remote control 102 may then transmit the control instruction using the communication subsystem 112 over network connection 130 to the drone 116.

The remote control 102 may also include at least one processing unit (e.g., a central processing unit, a graphical processor, an application-specific integrated circuit) that includes one or more cores. The at least one processing unit may execute software stored on the remote control 102 to perform the functions described herein of the remote control 102.

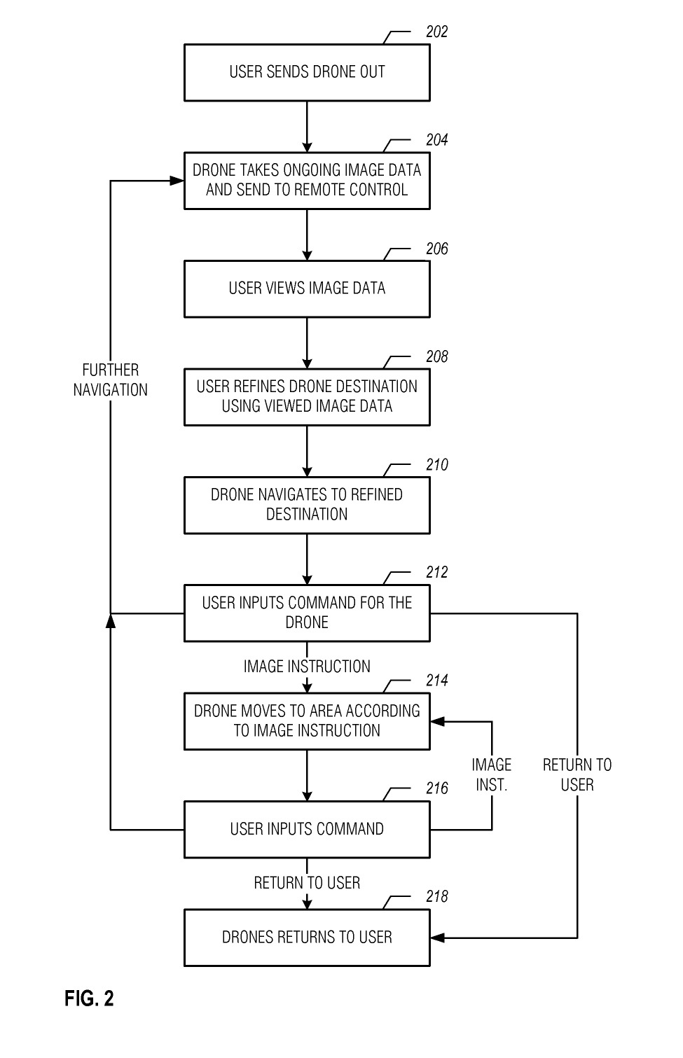

FIG. 2 is a flow chart illustrating a method to control a drone, according to various examples. The method may be performed by any of the modules, logic, or components described herein. In an example, at operation 202, a user sends a drone (e.g., the drone 116) out into an environment. The user may provide an initial destination for the drone to fly towards using a user interface on a remote control. At operation 204, the drone takes ongoing image data and sends it to a remote control.

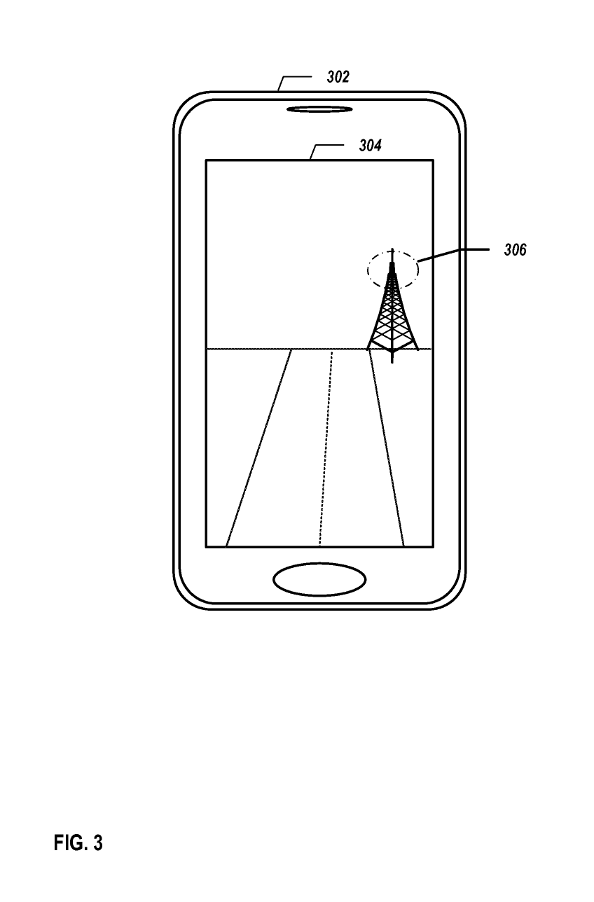

For example, FIG. 3 illustrates a user interface for controlling a drone. As illustrated, FIG. 3 includes a smart phone remote control 302, user interface 304, and control input 306. In an example, the control input 306 is an oval on the user interface 304 that represents a touch gesture made on the display device of the remote control 302. The user interface 304 may include the image data that was transmitted by the drone at operation 204.

Returning to FIG. 2, in an example, at operation 208, the user refines the drone destination using the viewed image data. For example, the user may use the control input 306 to indicate that the drone should navigate to the radio tower illustrated in the user interface 304. In an example, the remote control transmits a navigation instruction to the drone indicating the drone should navigate towards the radio tower. At operation 210, the drone navigates to the refined destination, according to an example embodiment,

In an example, at operation 212, a user inputs a command for the drone. For example, the user may use provide a control input on the remote control 302. As indicated previously, the control input may be touch input, voice input, spatial gestures, or device input (e.g., movement of the remote control).

In various examples, a control input may be associated with an actionable object of the image data. As discussed above, the object detection and recognition module 108 may analyze the image data to determine objects within the image. Thus, when a control input is drawn on the image data, the control module 110 may determine if the control input is directed towards one of the detected objects. This determination may include comparing the location of the touch input with the location (e.g., pixel coordinates) of the detected objects.

In various examples, actionable objects in the image data are delineated in the image data. Delineation may include shading the color of part of the image data that includes the actionable object or outlining the object. In an example, a user may select (e.g., tap or press) an actionable object before making the control input. The selection may be used by the control module 110 to know what object the control input is associated with.

In various examples, the control input may map to a control instruction for the drone. Accordingly, the control module 110 may query the command database 114 to determine the control instruction associated with the control input. The control instruction may be transmitted to the drone. The control instruction may also identify the actionable object in the image data for which the control instruction is associated.

In an example at operation 214, the drone moves to an area according to an image instruction. Image instructions may include but are not limited to, moving towards a specific object, focusing on a specific object, hovering near an object to take image data, changing the focal depth of a camera, on the drone, changing the exposure settings of a camera, and changing the frame-rate of video being captured.

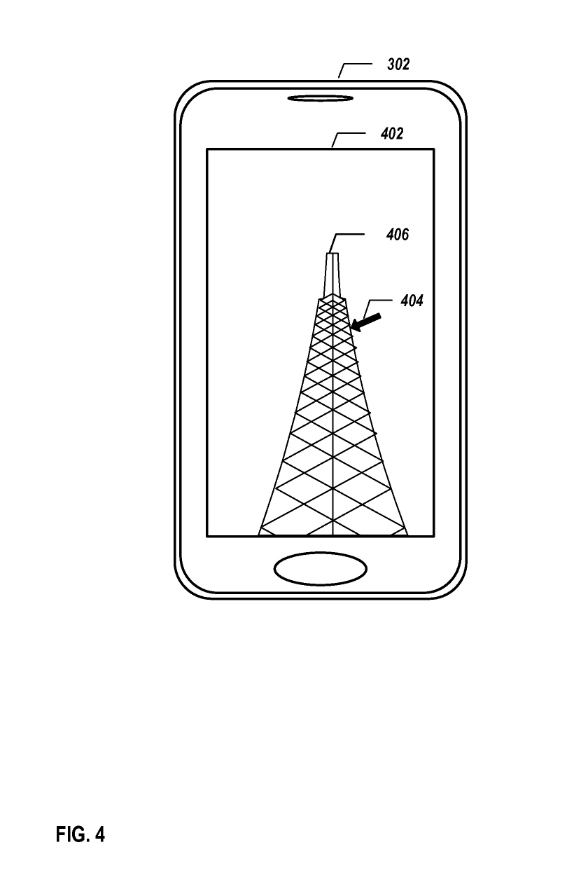

For example, FIG. 4 illustrates a hover command 404 on a user interface for controlling a drone. As illustrated, the user interface 402 is presented on a display device of the remote control 302. The user interface 402 may include updated image data received by the drone once the drone arrives at the refined destination. The hover command 404 is represented by an arrow pointing towards part of a radio tower 406. In an example, the radio tower 406 has been identified by the object detection and recognition module 108 as an actionable object. Because the arrow is pointing towards the radio tower 406, the control module 110 may determine that the hover command is associated with the radio tower 406. Accordingly, a control instruction may be transmitted to the drone to hover above the radio tower 406.

In various examples, control inputs that use touch are drawn on the display device of the remote control 302—allowing a user to see the gestures being made. In an example, the control inputs are not displayed on the display device. Furthermore, the discussion of specific gestures and associated commands illustrated in FIGS. 3-7 are examples, and other gestures may be used for the commands. For example, a circle gesture may be used for a hover command and an arrow may be used for refining navigation.

In an example, at operation 216 another command is inputted by the user. If the command is an image instruction, flow may return to operation 214. If the command is another command, such as a return to user command, at operation 218, the drone is instructed to return to the user.

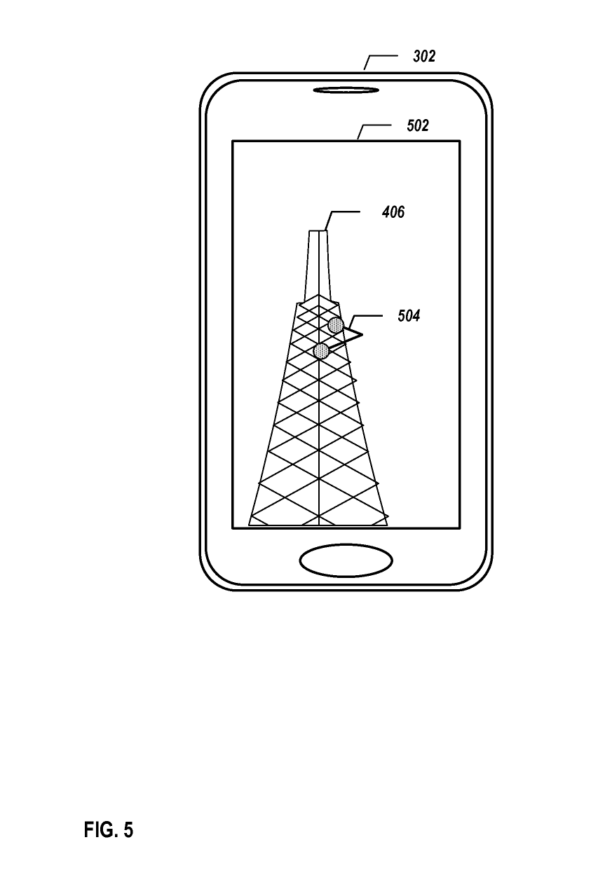

In various examples, FIG. 5 illustrates a focus command 504 on a user interface for controlling a drone. As illustrated, the user interface 502, including a closer view of the radio tower 406, is presented on a display device of the remote control 302. The focus command 504 is represented by two circles indicating the control input a multi-touch input on the display device of the remote control 302. In an example, the focus command 504 tells the drone where to focus in the image data. In an example, focusing on the object may also tell the drone to center on the object or to acquire a higher definition image of that area than is currently being taken.

In an example, the flight module 118 may translate the distance from center the frame of the image data into degrees of adjustment in the X, Y, and Z axes. A feedback loop with an analysis of each nth frame relative to the target pattern (e.g., the focal point) may allow the drone to compute the degrees and adjust to center the camera on the indicated focus point. In other example the display may have three-dimensional display capability, allowing the user to visualize depth more easily. Further, the display may allow simulated three-dimensional inputs to allow the user to more easily visual navigation commands.

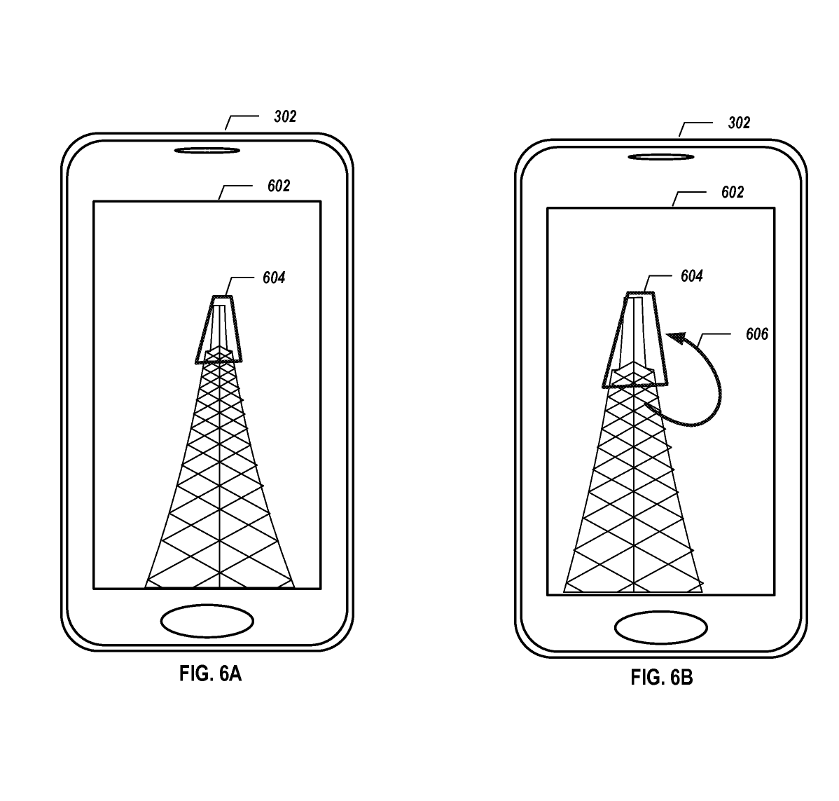

In various examples, FIGS. 6A and 6B illustrate a navigation command on a user interface for controlling a drone. As illustrated, the user interface 602 presents a structure with actionable object 604 outlined. FIG. 6A includes a farther out view of the actionable object 604 and FIG. 6B illustrates a closer view of the actionable object 604. FIG. 6B also illustrates control input 606. In an example, the closer view is not caused by the drone moving closer, by a user input on the display device (e.g., pulling apart two fingers). Thus, there may be inputs on the display device that are for the drone and others that manipulate the displayed image data.

In an example, the control input 606 indicates that a drone is supposed to fly to the other side of the actionable object 604. To determine the intent of various control inputs, the control module 110 may use the initial angle and location of a gesture and the ending location and angle of the gesture. For example, control input 606 may notice that the control input 606 begins in the center of actionable object 604, goes outside of the outline, and comes back towards the actionable object 604. Accordingly, the control module 110 may determine that an input that starts on an object, goes outside the object, and ends pointing towards the object is associated with a command to go behind the object. The control module 110 may also utilize the type of arrow point drawn at the end of a control input the intent of the command. Thus, the control module 110 may retrieve a control instruction from the command database 114 for the drone to achieve this result.

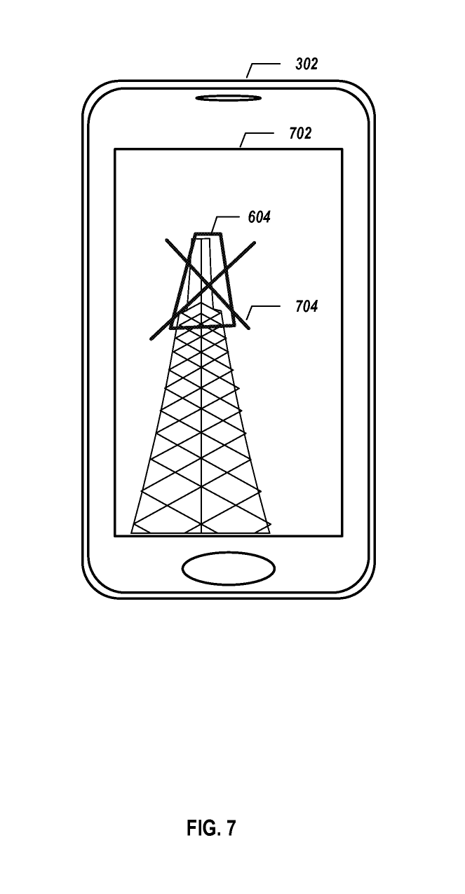

In various examples, a control input may be for direct action on an actionable object detected in the image data. For example, FIG. 7 illustrates a removal command 704 on a user interface 702 of a remote control 302. The removal command 704 is illustrated as a ‘X’ motion through the actionable object. The control module 110 may retrieve a control instruction for removing an object from the command database 114 and transmit the control instruction to the drone. The control instruction may also identity the object in the image data. The drone may utilize its modules and logic to remove the object.

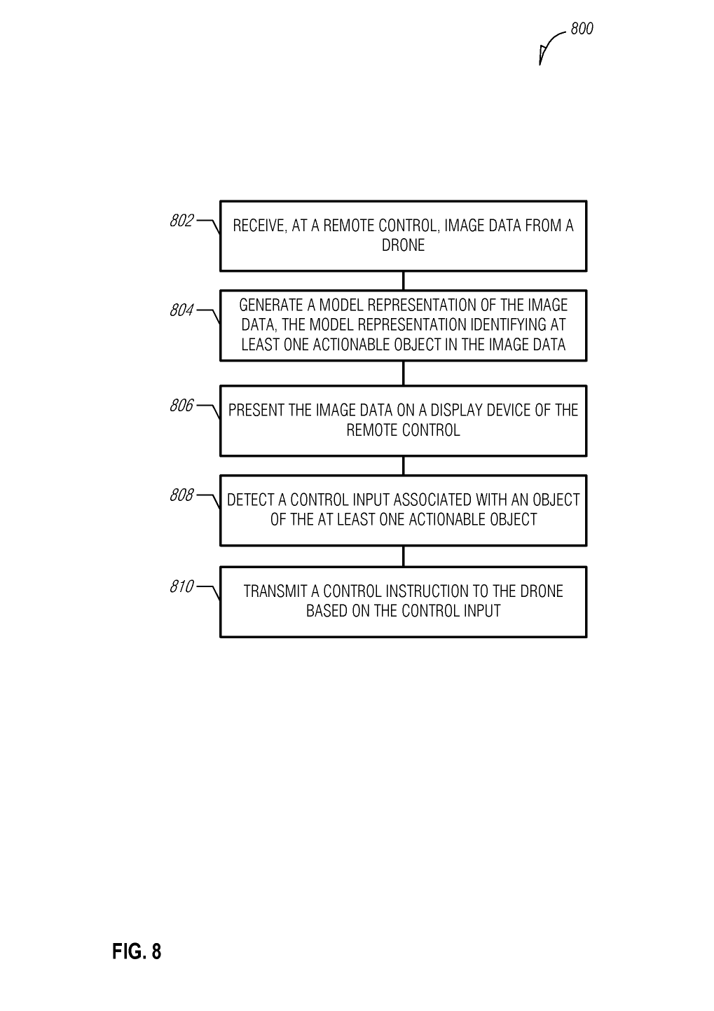

In various examples, FIG. 8 is a flow chart 800 illustrating a method to control a drone. The method may be performed by any of the modules, logic, or components described herein. In an example at operation 802, image data from the drone is received at a remote control. The image data may continuously be updated based on data captured by one or more sensors of a sensor array of the drone. In an example, the remote control is a smart phone. In an example, the drone is an unmanned aerial vehicle.

In an example, at operation 804, a model representation of the image data is generated. The model representation may identify at least one actionable object in the image data. The actionable objects in the model representation may be stored as metadata about the image data. The metadata may include the type of objects present in the image data and the locations of the object in the image data. For example, the metadata may indicate that there is a building in the image data between points (0, 0); (150, 0); (150, 45); and (0, 85). In various examples, the model representation may include a 3D model of the image data that may be manipulated by a user on the display device. Accordingly, objects may be defined using X, Y, and Z points. In an example, the model may be generated directly or indirectly by the object detection and recognition module.

In various examples, the actionable objects in the image data are not classified, but are based on delineations made by a user. For example, an object may be an X by X area of the image centered on a user's touch. This area may be identified again in the image data during navigation of the drone using pattern matching. Accordingly, the drone may navigate towards objects even if the nature (e.g., if the object is a road, etc.) of the object is unknown. Similarly, the generation of the model representation may be based on these delineations.

In an example, the image data is transmitted to an object detection server that is external to the remote control. For example, an application programming interface (API) call may be made to the object detection server with the image data. In response, the object detection server may transmit back the model representation including the one or more locations in the image data of the at least one actionable object (e.g., the metadata).

In an example, at operation 806, the image data is presented on a display device of the remote control. In an example, the at least one actionable object is highlighted in the image data. For example, an actionable item may be outlined. In an example, an actionable object is highlighted based on selection (e.g., touch) of the objet in the image data.

In an example, at operation 808, a control input is detected. The control input may be a touch gesture on the display device. In an example, detection is based on receiving information from an operating system of the remote control that the user made the control input. The control input may be associated with an object of the at least one actionable object. In an example, a command database is queried with the control input and the control instruction is received in response to the query. The query may also include the type of the drone.

In an example, at operation 810, a control instruction is transmitted to the drone based on the control input. In an example, an acknowledgement is received at the remote control that the control instruction was executed. After or during execution of the control instruction, the drone may transmit back updated image data. The model representation may then be updated based on the updated image data. In an example, the model representation, including metadata, may be transmitted to the drone 116 along with the control instruction.

In various examples, a navigation instruction is transmitted when the control input is a navigation gesture. Determining the type of control input may include using a control module as described above with reference to the control module 110. In an example, an object manipulation instruction may be transmitted when the control input is a manipulation gesture, and wherein the control instruction identifies the object. In various examples the system may present imagery on the remote and generate a model of a portion of the image only after the user has made a selection of a portion of the imagery.

### Example Computer System

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

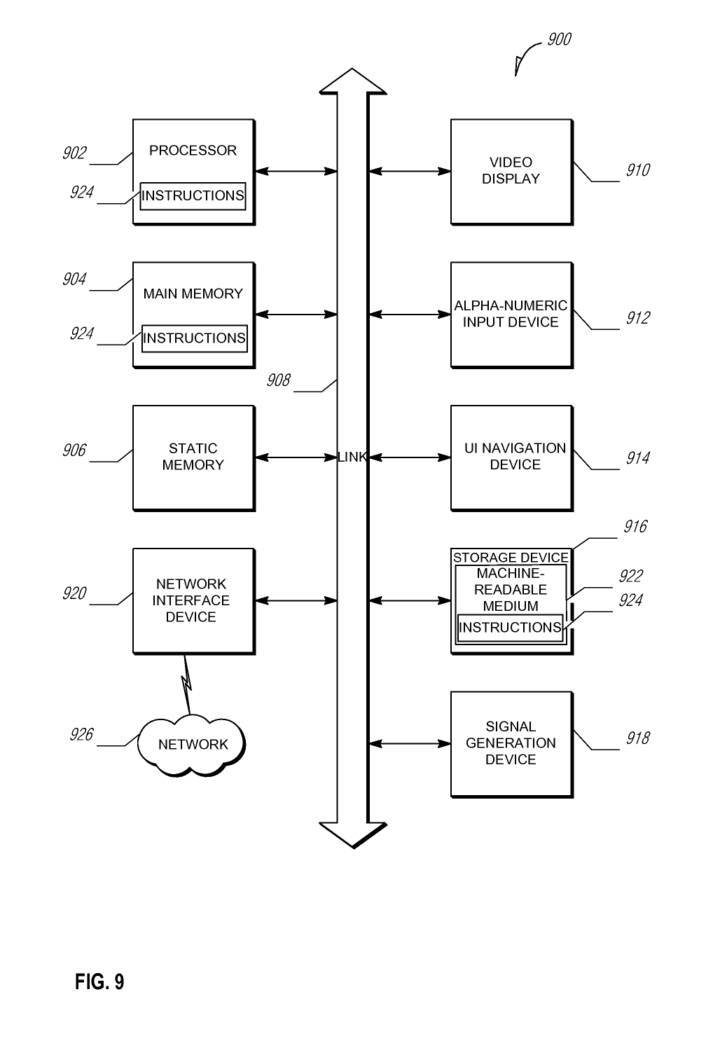

FIG. 9 is a block diagram illustrating a machine in the example form of a computer system 900, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 900 includes at least one processor 902 (e.g., a central processing unit (CPU), a graphics processing unit (GPU) or both, processor cores, compute nodes, etc.), a main memory 904 and a static memory 906, which communicate with each other via a link 908 (e.g., bus). The computer system 900 may further include a video display unit 910, an alphanumeric input device 912 (e.g., a keyboard), and a user interface (UI) navigation device 914 (e.g., a mouse). In one embodiment, the video display unit 910, input device 912 and UI navigation device 914 are incorporated into a touch screen display. The computer system 900 may additionally include a storage device 916 (e.g., a drive unit), a signal generation device 918 (e.g., a speaker), a network interface device 920, and one or more sensors (not shown), such as a global positioning system (GPS) sensor, compass, accelerometer, or other sensor.

The storage device 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904, static memory 906, and/or within the processor 902 during execution thereof by the computer system 900, with the main memory 904, static memory 906, and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Example 1 includes subject matter for transmission of instructions to a drone (such as a device, apparatus, or machine) comprising: a communication subsystem to receive image data from the drone; an object detection and recognition module to generate a model representation of the image data, the model representation identifying at least one actionable object in the image data; a display device to present the image data; and a control module to: detect a control input associated with an object of the at least one actionable object; and transmit a control instruction to the drone based on the control input.

In Example 2, the subject matter of Example 1 may include, wherein to generate the model representation of the image data, the object detection and recognition module is to: transmit the image data from to an object detection server; and receive the model representation from the object detection server, the model representation including at least one location in the image data of the at least one actionable object.

In Example 3, the subject matter of any one of Examples 1 to 2 may include, a command database; and wherein the control module is to query the command database with the control input to receive a control instruction.

In Example 4, the subject matter of any one of Examples 1 to 3 may include, wherein the query includes a type of the drone.

In Example 5, the subject matter of any one of Examples 1 to 4 may include, wherein the object in the image data is highlighted on the display device.

In Example 6, the subject matter of any one of Examples 1 to 5 may include, wherein the control module is to receive a selection input on the object and the display device is to highlight the object in the image data.

In Example 7, the subject matter of any one of Examples 1 to 6 may include, wherein the communication subsystem is to receive an acknowledgment from the drone that the control instruction was executed.

In Example 8, the subject matter of any one of Examples 1 to 7 may include, wherein the communication subsystem is to receive updated image data from the drone; and the object detection and recognition module is to update the model representation of the image data based on the updated image data.

In Example 9, the subject matter of any one of Examples 1 to 8 may include, wherein the control instruction is a navigation instruction when the control input is a navigation gesture.

In Example 10, the subject matter of any one of Examples 1 to 9 may include, wherein the control instruction is an object manipulation instruction when the control input is a manipulation gesture, and wherein the control instruction identifies the object.

In Example 11, the subject matter of any one of Examples 1 to 10 may include, wherein the control input is a touch gesture on the display device.

In Example 12, the subject matter of any one of Examples 1 to 11 may include, wherein the image data is received from an unmanned aerial vehicle.

In Example 13, the subject matter of any one of Examples 1 to 12 may include, wherein the display device is a display of a smartphone.

Example 14 includes subject matter for transmission of instructions to a drone (such as a method, means for performing acts, machine readable medium including instructions that when performed by a machine cause the machine to performs acts, or an apparatus to perform) comprising: receiving, at a remote control, image data from the drone; generating a model representation of the image data, the model representation identifying at least one actionable object in the image data; presenting the image data on a display device of the remote control; detecting a control input associated with an object of the at least one actionable object; and transmitting a control instruction to the drone based on the control input.

In Example 15, the subject matter of Example 14 may include, wherein generating the model representation of the image data comprises: transmitting the image data from the remote control to an object detection server; and receiving the model representation from the object detection server, the model representation including at least one location in the image data of the at least one actionable object.

In Example 16, the subject matter of any one of Examples 14 to 15 may include, querying a command database with the control input; and receiving the control instruction in response to the query.

In Example 17, the subject matter of any one of Examples 14 to 16 may include, wherein querying the command database includes querying the command database with a type of the drone.

In Example 18, the subject matter of any one of Examples 14 to 17 may include, highlighting the object in the image data presented on the display device.

In Example 19, the subject matter of any one of Examples 14 to 18 may include, receiving a selection input on the object; and highlighting the object in the image data on the display device.

In Example 20, the subject matter of any one of Examples 14 to 19 may include, receiving an acknowledgment from the drone that the control instruction was executed.

In Example 21, the subject matter of any one of Examples 14 to 20 may include, receiving updated image data from the drone; and updating the model representation of the image data based on the updated image data.

In Example 22, the subject matter of any one of Examples 14 to 21 may include, wherein transmitting the control instruction includes transmitting a navigation instruction when the control input is a navigation gesture.

In Example 23, the subject matter of any one of Examples 14 to 22 may include, wherein transmitting the control instruction includes transmitting an object manipulation instruction when the control input is a manipulation gesture, and wherein the control instruction identifies the object.

In Example 24, the subject matter of any one of Examples 14 to 23 may include, wherein the control input is a touch gesture on the display device.

In Example 25, the subject matter of any one of Examples 14 to 24 may include, wherein receiving image data includes receiving image data from an unmanned aerial vehicle.

In Example 26, the subject matter of any one of Examples 14 to 25 may include, wherein the remote control is a smart phone.

Example 27 includes at least one machine-readable medium including instructions, which when executed by a machine, cause the machine to perform operations of any of the Examples 14-26.

Example 28 includes an apparatus comprising means for performing any of the Examples 14-26.

Example 29 includes subject matter for transmission of instructions to a drone (such as a device, apparatus, or machine) comprising: means for receiving, at a remote control, image data from the drone; means for generating a model representation of the image data, the model representation identifying at least one actionable object in the image data; means for presenting the image data on a display device of the remote control; means for detecting a control input associated with an object of the at least one actionable object; and means for transmitting a control instruction to the drone based on the control input.

In Example 30, the subject matter of Example 29 may include, wherein the means for generating the model representation of the image data comprises: means for transmitting the image data from the remote control to an object detection server; and means for receiving the model representation from the object detection server, the model representation including at least one location in the image data of the at least one actionable object.

In Example 31, the subject matter of any one of Examples 29 to 30 may include, means for querying a command database with the control input; and means for receiving the control instruction in response to the query.

In Example 32, the subject matter of any one of Examples 29 to 31 may include, wherein the means for querying the command database include means for querying the command database with a type of the drone.

In Example 33, the subject matter of any one of Examples 29 to 32 may include, means for highlighting the object in the image data presented on the display device.

In Example 34, the subject matter of any one of Examples 29 to 33 may include, means for receiving a selection input on the object; and means for highlighting the object in the image data on the display device.

In Example 35, the subject matter of any one of Examples 29 to 34 may include, means for receiving an acknowledgment from the drone that the control instruction was executed.

In Example 36, the subject matter of any one of Examples 29 to 35 may include, means for receiving updated image data from the drone; and means for updating the model representation of the image data based on the updated image data.

In Example 37, the subject matter of any one of Examples 29 to 36 may include, wherein the means for transmitting the control instruction include means for transmitting a navigation instruction when the control input is a navigation gesture.

In Example 38, the subject matter of any one of Examples 29 to 37 may include, wherein the means for transmitting the control instruction include means for transmitting an object manipulation instruction when the control input is a manipulation gesture, and wherein the control instruction identifies the object.

In Example 39, the subject matter of any one of Examples 29 to 38 may include, wherein the control input is a touch gesture on the display device.

In Example 40, the subject matter of any one of Examples 29 to 39 may include, wherein the means for receiving image data includes mean for receiving image data from an unmanned aerial vehicle.

In Example 41, the subject matter of any one of Examples 29 to 40 may include, wherein the remote control is a smart phone.

What is claimed is:

1. A system for transmission of instructions to a drone, the system comprising:
a communication subsystem to receive image data from the drone;
an object detection and recognition module to generate a model representation of the image data, the model representation identifying at least one actionable object in the image data;
a display device to present the image data; and
a control module to:
detect a control input associated with an object of the at least one actionable object; and
transmit a control instruction to the drone based on the control input.

2. The system of claim 1, wherein to generate the model representation of the image data, the object detection and recognition module is to:
transmit the image data from to an object detection server; and
receive the model representation from the object detection server, the model representation including at least one location in the image data of the at least one actionable object.

3. The system of claim 1, further comprising:
a command database; and
wherein the control module is to query the command database with the control input to receive a control instruction.

4. The system of claim 3, wherein the query includes a type of the drone.

5. The system of claim 1, wherein the object in the image data is highlighted on the display device.

6. The system of claim 1, wherein the control module is to receive a selection input on the object and the display device is to highlight the object in the image data.

7. The system of claim 1, wherein the communication subsystem is to receive an acknowledgment from the drone that the control instruction was executed.

8. The system of claim 7, wherein the communication subsystem is to receive updated image data from the drone; and the object detection and recognition module is to update the model representation of the image data based on the updated image data.

9. A method for transmitting instructions to an drone, the method comprising:
receiving, at a remote control, image data from the drone;
generating a model representation of the image data, the model representation identifying at least one actionable object in the image data;
presenting the image data on a display device of the remote control;
detecting a control input associated with an object of the at least one actionable object; and
transmitting a control instruction to the drone based on the control input.

10. The method of claim 9, wherein generating the model representation of the image data comprises:
transmitting the image data from the remote control to an object detection server; and
receiving the model representation from the object detection server, the model representation including at least one location in the image data of the at least one actionable object.

11. The method of claim 9, further comprising:
querying a command database with the control input; and
receiving the control instruction in response to the query.

12. The method of claim 11, wherein querying the command database includes querying the command database with a type of the drone.

13. The method of claim 9, further comprising:
highlighting the object in the image data presented on the display device.

14. The method of claim 9, further comprising:
receiving a selection input on the object; and
highlighting the object in the image data on the display device.

15. The method of claim 9, further comprising:
receiving an acknowledgment from the drone that the control instruction was executed.

16. The method of claim 15, further comprising:
receiving updated image data from the drone; and
updating the model representation of the image data based on the updated image data.

17. At least one machine-readable medium including instructions, which when executed by a machine, cause the machine to perform operations comprising:
receiving, at a remote control, image data from an drone;
generating a model representation of the image data, the model representation identifying at least one actionable object in the image data;
presenting the image data on a display device of the remote control;
detecting a control input associated with an object of the at least one actionable object; and
transmitting a control instruction to the drone based on the control input.

18. The at least one machine-readable medium of claim 17, wherein the operation of generating the model representation of the image data comprises:
transmitting the image data from the remote control to an object detection server; and
receiving the model representation from the object detection server, the model representation including at least one location in the image data of the at least one actionable object.

19. The at least one machine-readable medium of claim 17, wherein the operations further comprise:
querying a command database with the control input; and
receiving the control instruction in response to the query.

20. The at least one machine-readable medium of claim 17, wherein querying a command database with the control input includes querying the command database with a type of the drone.

21. The at least one machine-readable medium of claim 17, wherein the operations further comprise:
receiving a selection input on the object; and
highlighting the object in the image data on the display device.

22. The at least one machine-readable medium of claim 17, wherein the operations further comprise:
highlighting the object in the image data presented on the display device.

23. The at least one machine-readable medium of claim 17, wherein the operations further comprise:
receiving an acknowledgment from the drone that the control instruction was executed.

24. The at least one machine-readable medium of claim 23, wherein the operations further comprise:
receiving updated image data from the drone; and
updating the model representation of the image data based on the updated image data.

25. The at least one machine-readable medium of claim 17, wherein the control input is a touch gesture on the display device.
